(19) United States
(12) Patent Application Publication
(10) Pub. No.: US 2019/0182239 A1
(43) Pub. Date: Jun. 13, 2019

(54) METHOD OF SECURING AN ELECTRONIC TRANSACTION

(71) Applicant: IDEMIA IDENTITY & SECURITY FRANCE, Courbevoie (FR)

(72) Inventors: Julien BRINGER, COURBEVOIE (FR); Claire DURAND, COURBEVOIE (FR)

(21) Appl. No.: 16/212,860

(22) Filed: Dec. 7, 2018

(30) Foreign Application Priority Data
Dec. 8, 2017 (FR) 17 61869

(51) Int. Cl. H04L 29/06; G06Q 20/38; G06Q 20/32

(52) U.S. Cl. CPC H04L 63/0838; H04L 63/061; H04W 12/0608; G06Q 20/322; H04L 2463/082; G06Q 20/385

(57) ABSTRACT

A method of securing a transaction carried out by a user having a computer unit connected to a computer server via a computer network, the user having a telecommunications terminal arranged to access a telephone network. The method includes a prior step of registering a synchronization parameter in the terminal, which parameter is shared with the server and varies in synchronized manner in the terminal and in the server. When the terminal cannot be connected to the telephone network, authentication is performed from a temporary code calculated by the terminal on the basis of the synchronization parameter and of a personal code of the user.

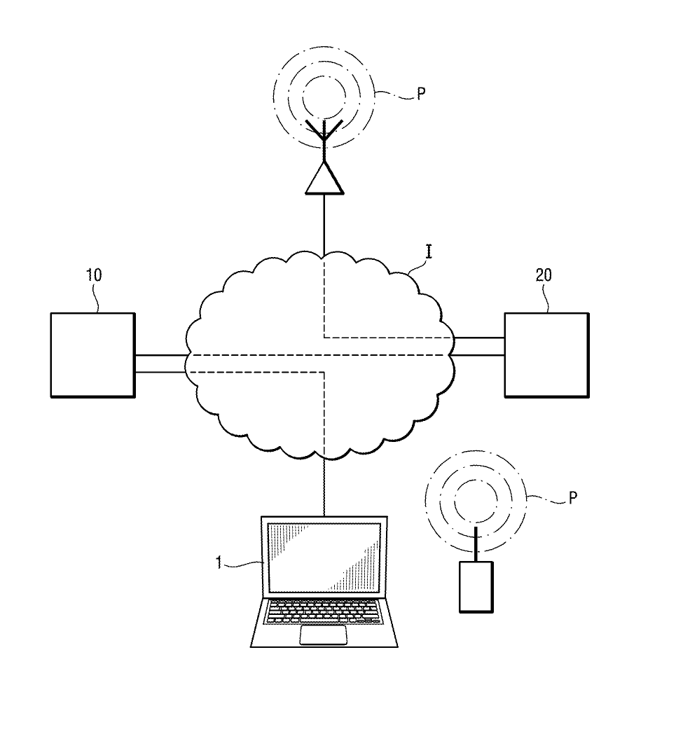

The present invention relates to the field of transactions carried out between a server and a computer connected to the server via a network such as the Internet.

### STATE OF THE ART

It is known to carry out commercial transactions between a commercial server and a computer that is connected to the commercial server via the Internet. Such transactions often include a financial operation such as authorizing debiting a bank account or making a payment that is validated by inputting bank card data. The commercial server is generally associated with a bank server that is to register said financial operation.

The difficulty of such a remote commercial transaction is to ensure that the user carrying out the commercial transaction and requesting payment is indeed a person authorized to use the payment means in question and not, for example, a person who has found a bank card or who has stolen it from its proprietor.

The best known means for this purpose consist in supplying a code that is personal to the user so as to enable the user to be authenticated by inputting that user's own personal code to the web page presented by the bank server.

Nevertheless, if the personal code is intercepted by a third party, then that third party can reuse it in order to carry out fraudulent transactions.

In order to avoid the personal code passing in the clear over the Internet, it is known to have recourse to a one-time password (OTP) that is sent by the bank organization to the user over some other channel, generally a mobile terminal connected to the cell phone (or GSM) telephone network. The user then needs to input the OTP into a dedicated field displayed on the user's computer. Nevertheless, this assumes that the user can be connected to the cell phone network.

### OBJECT OF THE INVENTION

An object of the invention is to provide means for making transactions secure, including authentication via a network to which the user temporarily does not have access.

### BRIEF SUMMARY OF THE INVENTION

To this end, the invention provides a method of securing a transaction carried out by a user having a computer unit connected to a computer server via a first network, the user having a telecommunications terminal arranged to access a second network. The method comprises a prior step of storing in the terminal a synchronization parameter that is shared with the server and that varies in synchronized manner both in the terminal and in the server, and, when the terminal cannot be connected to the second network, the method initiates an alternative authentication stage comprising the steps of:
requesting the user to input into the computer unit a temporary code calculated by the terminal on the basis of the synchronization parameter and of a personal code of the user; and
forwarding the code to the server so that the server compares it with a temporary code calculated by the server on the basis of the synchronization parameter and of a verifier corresponding to the user's personal code, authentication being validated if the calculated code corresponds to the received code.

For example, the first network may be a computer network such as the Internet; the second network may be a network that is independent of the first, such as the telephone network; the computer unit may be a computer; and the terminal may be a smartphone type mobile telephone.

The method of the invention thus enables the user to be authenticated by means of the user's personal code, which is not transmitted as such to the network but which is used for forming the temporary code. Authentication is thus performed on the basis of two factors, namely the personal code and the synchronization parameter, with the synchronization parameter optionally including a shared key. The terminal does not need to verify the validity of the personal code since that is verified indirectly during verification by the server of the temporary code.

Other characteristics and advantages of the invention appear on reading the following description of particular, non-limiting implementations of the invention.

### BRIEF DESCRIPTION OF THE FIGURE

Reference is made to the sole accompanying FIGURE, which is a diagram showing the overall architecture of a system suitable for use in implementing the invention.

### DETAILED DESCRIPTION OF THE INVENTION

With reference to the FIGURE, the method of the invention enables transactions, e.g. commercial or financial transactions, to be carried out between a computer 1 of a user and a transaction server 10 of a trader or of a bank organization. The computer 1 and the server 10 are connected to a computer network, specifically the Internet I.

The transaction server 10 is programmed in known manner to enable the computer 1 to connect to the transaction server 10 via the Internet I to carry out a commercial transaction such as purchasing a product or a financial transaction such as making a bank transfer. The invention does not relate to the transaction itself but rather to making the transaction secure. This security relies on authenticating the user so as to enable the transaction server 10 to be sure that the person requesting the transaction is indeed a user having the right to carry out the transaction.

In order to perform authentication, the transaction server 10 is arranged to connect to an authentication server 20 that is itself connected to the Internet I. The authentication server 20 has means for connecting to the cell phone network P forming part of the telephone network. By way of example, the cell phone network P may be of the GSM type.

The user also has a telecommunications terminal, specifically a smart phone type telephone 30, which is arranged to access the telephone network P.

The computer 1, the transaction server 10, the authentication server 20, and the telephone 30 all have processors and memories in order to be able to execute computer programs comprising instructions suitable for performing the method of the invention.

At a moment in the transaction, the user is requested by the transaction server 10 to agree to transferring money. For this purpose, the transaction server 10 displays a dedicated web page on the computer 1, in which page the user is to input:
either, in the context of a commercial transaction, information about the user's bank card (such as the user's name, the bank card number, the expiry date, and a cryptogram);
or else, in the context of a financial transaction, an account number and an associated code.

Thereafter, the transaction server 10 is programmed to display a web page on the computer 1 asking the user to:
input a temporary code that is to be transmitted to the user's telephone 30 (nominal authentication stage); or
select an alternative authentication stage.

The nominal authentication stage relies on the authentication server 20 sending a temporary code to the telephone 30 via the cell phone network P, and the user inputting that code into the computer 1 in order to authenticate the user with the authentication server 20. The term “nominal” temporary code is used for the temporary code that is used during the nominal authentication stage.

The authentication stage takes place as follows:
the telephone 30 sends a request via the cell phone network P to obtain a nominal temporary code from the authentication server 20;
the authentication server 20 then initiates a connected mode authentication procedure by interacting via the cell phone network P with the terminal (which includes requesting the user to input the user's personal code into the telephone 30 so that the code is validated by the authentication server 20);
once the user has been authenticated, the authentication server 20 transmits the nominal temporary code to the telephone 30, and the user inputs it into the web page.

The computer 1 then transmits the nominal temporary code to the transaction server 10, which forwards it to the authentication server 20. The authentication server 20 compares the nominal temporary code it has just received with the nominal temporary code that it sent. The authentication server 20 validates authentication if the nominal temporary codes correspond to each other and it informs the transaction server 10, which then completes the transaction. If the nominal temporary codes do not correspond, the authentication server 20 invalidates authentication and informs the transaction server 10, which then interrupts the transaction by displaying an error message on the computer 1.

It should be observed that a connection is initiated between the transaction server 10 and the computer 1, and that a connection is initiated between the transaction server 10 and the authentication server 20 via the Internet I. The authentication server 20 is connected to the user only via the telephone 30 and the cell phone network P.

If the user so desires, or if the telephone 30 is unable to access the cell phone network P, the user may select the alternative authentication stage.

The transaction server 10 then displays a web page on the computer 1 requesting a temporary code to be input, which code is referred to as herein as the alternative temporary code.

In order for it to be possible to perform the alternative authentication stage, the memory and telephone 30 have stored therein:
a personal code;
a verification formula for calculating a verifier from the personal code;
a synchronization parameter; and
a predetermined mathematical formula for calculating the alternative temporary code.

The memory of the authentication server 20 has stored therein for each registered user:
the verifier;
a synchronization parameter; and
the predetermined mathematical formula for calculating the alternative temporary code.

By way of example, suitable authentication algorithms include the following algorithms: HMAC-based one-time password (HOTP); time-based one-time password (TOTP); OATH challenge-response algorithm (OCRA); . . . . By way of example, the verifier is calculated in the same manner as in the following protocols: secure remote password (SPR); verifier-based password authenticated key exchange (VPAKE); or by hashing on the basis of a random number (also known as “salt”). It should be observed that in the invention, these algorithms are not applied to a single key, as they are usually, but rather to a combination of the personal code and of the synchronization parameter. A calculation example is given below using an HOTP or a TOTP algorithm.

The telephone 30 and the authentication server 20 both execute an alternative authentication program, which is arranged to cause the synchronization parameter to vary and to calculate a temporary code on the basis of the synchronization parameter. The synchronization parameter needs to vary in synchronized manner in the telephone 30 and in the authentication server 20. For this purpose, the variation rule is known both to the telephone 30 and to the authentication server 20. In a first implementation, the synchronization parameter comprises a date and a time: this data is already used by the telephone 30 and the authentication server 20 for other purposes such as displaying the date and the time, for making connections to the Internet I, . . . . This date and time data naturally varies as time passes. In a second implementation, the synchronization parameter is equal to the sum of the number of successful alternative authentications plus an initial incrementation value. For example, the initial incrementation value may be equal to 5, and the synchronization parameter is thus equal to the number of successful alternative authentications plus 5. The synchronization parameter is thus increased by a predetermined amount each time an alternative authentication stage is successful. The synchronization parameter may also comprise a secret key that is shared between the server and the terminal, combined by a mathematical formula with the date and time data or the sum of the number of successful alternative authentications and an initial incrementation value.

In order to calculate the alternative temporary code, the user then executes the alternative authentication program on the telephone 30. The program asks the user to input a personal code, recovers or calculates the synchronization parameter, and then calculates the alternative temporary code on the basis of the synchronization parameter and of the user's personal code. More precisely in this example, the alternative temporary code is calculated by the telephone 30 by means of a step of calculating the verifier by applying the verification formula to the personal code and then by applying the predetermined mathematical formula to the verifier and to the synchronization parameter in order to obtain the alternative temporary code.

The user inputs the alternative temporary code into the computer 1, which forwards it to the transaction server 10. The transaction server 10 then forwards the alternative temporary code to the authentication server 20, which compares it with an alternative temporary code calculated by the authentication server 20 on the basis of the synchronization parameter and of the verifier corresponding to the user's personal code. Calculation of the alternative temporary code by the authentication server 20 includes the step of applying the predetermined mathematical formula to the verifier and to the synchronization parameter in order to obtain the alternative temporary code. Authentication is validated if the calculated alternative temporary code corresponds to the alternative temporary code as received. If the alternative temporary codes do not correspond, the authentication server 20 invalidates authentication and informs the transaction server 10, which then interrupts the transaction by displaying an error message on the computer 1.

There follows a description of an example implementation making use of the HOTP or TOTP algorithm.

There is a prior exchange of a shared key K between the terminal and the server, both of which store the key K, and a synchronization value sync is synchronized between the terminal and the server. The server also stores a verifier v. The verifier v is obtained by calculation using a predetermined formula applied to the user's personal code, which itself is not stored in the server.

The authentication stage takes place as follows:
the user inputs the user's personal code into the terminal, which then calculates in succession: a verifier vPIN of the personal code, a derived key K′ by combining K and vPIN (e.g. K′=H(K,vPIN)); and then generates the alternative temporary code OTP using a mathematical function F such that OTP=F(K′, sync);
the alternative temporary code is then input into the computer and sent to the server;
the server calculates that a derived key K″ from the key K and the verifier v, and then verifies that the received temporary code OTP is such that OTP=(K″, sync);
if the temporary code is found to be valid, then the keys K″ and K′ are identical with a high degree of probability, and thus v=vPIN. The authentication is thus positive.

In the first implementation using a synchronization parameter based on date and time data, the authentication server applies a margin of error to take account of the length of time taken to convey the alternative temporary code from the computer 1 to the authentication server 20. The authentication server 20 calculates as many alternative temporary codes as there are possible temporary codes given the margin of error, and it compares the received alternative temporary code with each of the alternative temporary codes it has calculated: authentication is validated if one of the calculated alternative temporary codes corresponds to the alternative temporary code as received. By way of example, the margin of error may be one minute, and sixty alternative temporary codes are calculated.

In the second implementation, provision is made for a margin of error concerning alternative authentication attempts, with this margin of error being five alternative authentication attempts, for example. The authentication server 20 calculates five alternative temporary codes corresponding to the margin of error, and compares the alternative temporary code as received with each of the calculated alternative temporary codes: authentication is validated if one of the calculated alternative temporary codes corresponds to the alternative temporary code as received.

Preferably, the method includes the step of updating the synchronization parameter in the telephone 30 and the authentication server 20 when access to the cellphone network P is once again possible for the telephone 30 or when an authentication is validated.

Furthermore, for the transfer of the alternative temporary code, it is possible to use any mode of exchanging codes and/or any cryptographic method. For example, it is possible to use a server to server transmission protocol, e.g. HTTPS, SSL, or TLS.

In a variant of the invention, a random number is displayed on the computer 1 and the user inputs it into the telephone 30 in which the authentication program makes use of the random number in order to calculate the alternative temporary code. In a variant, there is no need to input the random number since it is scanned by the telephone. By way of example, the random number may be in the form of a QR code that is scanned by means of the camera of the telephone. There may also be local network communication between the terminal and the server (not only for this step, but also for “inputting” the temporary code into the webpage . . . ).

The authentication server likewise makes use of the random number for calculating the alternative temporary code.

It should be observed that other modes of nominal authentication can be envisaged. Preferably, a mode of authentication is selected that does not require the personal code to be transmitted to the server. For this purpose, preference may be given for example to using a verifier.

Thus, it is possible during nominal authentication to avoid sending a temporary code. It is then possible to make direct use of authentication of the user from the user's personal code and the associated verifier at the authentication server end, as implemented in the secure remote password (SRP) or the verifier-based password authenticated key exchange (VPAKE) protocols, or via a verifier calculated by hashing a random number (or “salt”).

Such a nominal authentication mode could be as follows:

1. the user inputs an identifier into the transaction server;

2. the transaction server sends the authentication server a request to authenticate this identifier;

3. the authentication server then initiates a user-connected mode authentication procedure by interacting with the terminal (which includes requesting the user to input the user's personal code into the terminal so that the code can be validated by the authentication server, e.g. using one of the above-mentioned protocols); and

4. once the user is authenticated, the authentication server forwards the positive result to the transaction server, which can then unlock access.

Naturally, the invention is not limited to the implementations described, but covers any variant coming within the ambit of the invention as defined by the claims.

In particular, the telecommunications terminal may be incorporated in the computer unit.

The computer unit may be a computer, a second server, or a multimedia tablet.

The computer unit may be connected to the computer network via a connection that is wired or wireless.

The personal code may be a string of alphanumeric characters input directly by the user or prepared on the basis of encoding a pattern traced by the user on a touchpad of the terminal or of encoding biometric characteristics as detected by a biometric sensor of the terminal.

The nominal authentication stage may begin directly with the stage of causing the authentication server 20 to send the nominal temporary code to the telephone 30 via the cell phone network P in such a manner that the user can input the nominal temporary code as received by the telephone 30 into the webpage displayed by the computer 1.

The method may be implemented by means of a single server performing both the authentication and the transaction functions.

The temporary code may be associated with the context of the transaction: information relating to the transaction (e.g. its type or its amount) may be combined with the personal code and with the synchronization parameter in order to calculate the temporary code.

1. A method of securing a transaction carried out by a user having a computer unit connected to a computer server via a first network, the user having a telecommunications terminal arranged to access a second network, the method comprising a prior step of storing in the terminal a synchronization parameter that is shared with the server and that varies in synchronized manner both in the terminal and in the server, and in that, when the terminal cannot be connected to the second network, the method enters into an alternative authentication stage comprising the steps of:
the computer unit forwarding to the server a temporary code calculated by the terminal on the basis of the synchronization parameter and of a personal code of the user;
the server comparing the received code with a code calculated by the server on the basis of the synchronization parameter and of a verifier corresponding to the user's personal code, authentication being validated if the calculated code corresponds to the received code.

2. The method according to claim 1, wherein the synchronization parameter depends on date and time data.

3. The method according to claim 2, wherein during authentication, the server applies a margin of error for taking account of the time taken to convey the temporary code.

4. The method according to claim 3, wherein the server calculates as many temporary codes as there are possible temporary codes given the margin of error, and it compares the received temporary code with each of the temporary codes it has calculated.

5. The method according to claim 1, wherein the synchronization parameter varies with the number of alternative authentication stages that are performed.

6. The method according to claim 5, wherein the synchronization parameter is increased by a predetermined value on each alternative authentication stage.

7. The method according to claim 1, wherein a random number is displayed on the computer and is communicated to the terminal, which uses a random number for calculating the temporary code, the server also using the random number for calculating the temporary code.

8. The method according to claim 1, including a nominal authentication stage comprising the steps of:
the user inputting an identifier into the server, referred to as the “transaction server”;
the transaction server sending a request to authenticate this identifier to a second server, referred to as the “authentication” server;
the authentication server then initiating a procedure for authenticating the user, including a request to the user to input the user's personal code into the terminal so that the code can be validated by the authentication server; and
once the user is authenticated, the authentication server forwards the positive result to the transaction server, which can then unlock access for the user to the transaction server.

9. The method according to claim 8, wherein the personal code is verified by using a verifier on the authentication server.

10. The method according to claim 1, including a nominal authentication stage comprising the steps of:
causing the server to send a nominal temporary code to the terminal via the second network;
requesting the user to input the nominal temporary code as received by the terminal into the computer unit; and
forwarding the code to the server so that the server compares it with the nominal temporary code as sent and so that it validates authentication if the nominal temporary codes match.

11. The method according to claim 1, including a nominal authentication stage comprising the steps of:
the terminal sending the authentication server a request via the cell phone network in order to obtain a nominal temporary code;
the authentication server then initiating a procedure for authenticating the user in connected mode by interacting with the terminal via the cell phone network, connected mode authentication including a request to the user to input the user's personal code into the terminal so that the nominal temporary code is unlocked by the authentication server;
once the user has been authenticated, the authentication server forwards the nominal temporary code to the terminal; and
forwarding the code to the server so that the server compares it with the nominal temporary code as sent and so that it validates authentication if the nominal temporary codes match.

12. The method according to claim 10, wherein sending of the temporary code is preceded by the step of enabling the user to initiate an alternative authentication stage, if so desired.

13. The method according to claim 8, including the step of updating the synchronization parameter when access to the second network is available.

14. The method according to claim 1, wherein during the alternative authentication stage, calculation of the temporary code by the terminal includes the step of calculating the verifier from the personal code and then applying a predetermined mathematical formula to the verifier and to the synchronization parameter, and calculation of the temporary code by the server includes the step of applying the predetermined mathematical formula to the verifier and to the synchronization parameter.

15. The method according to claim 14, wherein the alternative authentication stage makes use of one of the following authentication algorithms:
HOTP;
TOTP;
OCRA.

16. The method according to claim 14, wherein the verifier is calculated in the same manner as in the following protocols:
SRP;
VPAKE;
hashing from a random number.

17. The method according to claim 1, implemented by means of an authentication server connected to a transaction server connected to the computer unit, the method including the step of initiating respective connections between the transaction server and the computer unit, and between the transaction server and the authentication server, the authentication server being connected at the user end only to the terminal via the second network.
